(19) United States
(12) Patent Application Publication
(10) Pub. No.: US 2017/0140657 A1
(43) Pub. Date: May 18, 2017

(54) AUGMENTED REALITY TO DISPLAY FLIGHT DATA AND LOCATE AND CONTROL AN AERIAL VEHICLE IN REAL TIME

(71) Applicant: Black Swift Technologies LLC, Boulder, CO (US)

(72) Inventors: Jack S. Elston, Boulder, CO (US); Maciej Stachura, Boulder, CO (US); Cory Dixon, Denver, CO (US)

(21) Appl. No.: 15/345,473

(22) Filed: Nov. 7, 2016

Related U.S. Application Data
(60) Provisional application No. 62/252,822, filed on Nov. 9, 2015.

(51) Int. Cl. G08G 5/00; G06T 11/60; G08G 5/04; H04N 7/18

(52) U.S. Cl. CPC G08G 5/0082; H04N 7/183; G06T 11/60; G08G 5/0021; G08G 5/0039; G08G 5/0008; G08G 5/0013; G08G 5/045; G06F 3/048

(57) ABSTRACT

A system for displaying information related to the flight of an aerial vehicle that is comprised of a display, a camera that captures real-time video input from its surrounding environment, and a computing device that is coupled to, and communicates with the camera, a display, and one or more aerial vehicles. The computing device maps the current location and orientation of the camera to a display coordinate system. The flight data of the aerial vehicle is also mapped on the same display coordinate system. The computing device displays, on the display, the real-time video output that is comprised of the visual integration of the flight data and the real-time video input in the display coordinate system in relation to the present location and orientation of the camera.

### CROSS REFERENCE

This application is a non-provisional application claiming the benefit of Provisional Application No. 62/252,822 filed Nov. 9, 2015, which is incorporated by reference herein in its entirety for all purposes.

### TECHNICAL FIELD

Some embodiments relate generally to aerial vehicles and control and data associated therewith, and specifically to real time display and location of cooperative unmanned aerial vehicles and data associated therewith using portable field-technology.

### BACKGROUND

Methods and systems to control the real time flight path of an aerial vehicle are currently available in a number of different forms. One example of such a control system is a simple remote control. Methods and systems to view flight plan data are also well established in the avionics field. One prevalent example is the real time read-out of flight progress displayed for passengers on many commercial flights. While both items are useful, they are typically limited in various ways. For example, such environments generally do not enable an operator to prospectively map the flight plan over a real time image of the surroundings, to adjust the flight plan of the aerial vehicle (e.g., to avoid obstacles), etc.

Other current approaches to map and adjust the flight plan of an aerial vehicle can be limited in other ways. For example, certain technologies allow for the prospective creation of a flight plan but may not allow for real time adjustment. Other approaches fail to allow for the overlay of a flight plan on a real time image of the surrounding area. Still other approaches only allow the operator to view one aerial vehicle on the display and do not allow for display and/or control of multiple aerial vehicles.

### SUMMARY

Embodiments relate to a system and method for locating at least one aerial vehicle in an operating environment. An operating environment is a volume that contains both the operator and the UAV. The operating environment can be defined, in some instances, according to technical and/or legal limits, such as a maximum legal distance that the operator of an unmanned aerial device can be from the aerial device in accordance with Federal Aviation Administration (FAA) guidelines. Embodiments can employ a camera communicatively coupled with a computing device in communication with at least one aerial vehicle, such that the computing device can map a spatial orientation of the camera in relation to the at least one aerial vehicle over real-time video relayed from the camera via a display coordinate system. The display coordinate system can be global positioning satellite (GPS) coordinates, geographic information system (GIS) maps, or any other suitable mapping coordinate system. Additionally, the camera may relay additional information to the computing device such as that obtained from an Inertial Measurement Unit (IMU) or any suitable device that can compute and relay spatial orientation. The computing device is connected to a display that renders an image. The spatial orientation is used to compute the image frames, and the image frames are rendered to the display. The computing device, display and camera may be individual components or may be combined in one or more components, such as a tablet computer, a computer attached to a camera, or any other suitable devices.

In one embodiment, the system displays flight information related to multiple (e.g., all) aerial vehicles in the environment on the display. Flight information can relate to the past, present and/or future position of an aerial vehicle. The future position can reflect a predetermined flight path for the aerial vehicle, one or more estimated future positions of the aerial vehicle, etc. Flight information can also be an indicator showing that an aerial vehicle is in the operating environment but is not in a frame of view of the camera. This indicator can be an arrow on the display pointing in the direction of the aerial vehicle.

Certain embodiments may display one type of flight information while other embodiments may incorporate multiple aspects of flight information. Examples include current position of the aerial vehicle, future planned position of the aerial vehicle, past position of the aerial vehicle, orientation of the aerial vehicle, speed of the aerial vehicle, elevation of the aerial vehicle, pitch and yaw of the aerial vehicle, thrust of the aerial vehicle, remaining power of the aerial vehicle, make and model of the aerial vehicle, etc.

In another embodiment, one aerial vehicle is cooperative with the computing device. As used herein, “cooperative” means that a user can control the flight path of the aerial vehicle using the computing device. For example, changing the flight path in real time can enable the operator to steer a cooperative aerial vehicle around upcoming obstacles or alter the flight path for any other reason.

According to some embodiments, the computing device is directly in communication with the aerial vehicle (i.e., not via an intermediate communication station).

In another embodiment, the aerial vehicle communicates to a ground station that relays the signal to the computing device. A ground station can be another computing device that is communicatively coupled to the system's computing device or any other device that can receive a signal from an aerial vehicle and relay that signal to the computing device.

In still another embodiment, the aerial vehicle and the computing device are in communication via a network, such as the Internet.

According to some embodiments, the system displays flight information for multiple aerial vehicles on the same display, which may or may not be cooperative. In other embodiments, the system displays flight information related to a cooperative aerial vehicle.

In some embodiments, the flight information displayed represents the flight plan of a cooperative aerial vehicle. The flight plan represents a predetermined future position of the aerial vehicle. In this case, the aerial vehicle may or may not be in the air and may or may not be in the operating environment.

### BRIEF DESCRIPTION OF THE DRAWINGS

The accompanying figures illustrate one or more embodiments disclosed herein, and together with the detailed description, serve to explain the aspects and methods of implementation of the system. The figures are not intended to be to scale. Embodiments are described in conjunction with the appended figures:

FIG. 1 is a block diagram schematic of data transmission flow, according to an embodiment of the present disclosure.

FIG. 2 is a block diagram schematic of an embodiment for creating or changing a future flight plan.

FIG. 3 is a block diagram schematic of the components of an embodiment for use of a user interface.

FIG. 4 is an image of a user interface as it is displaying the location of both a cooperative and a communicative aerial vehicle.

FIG. 5 is an image of the user interface of FIG. 4 as it is displaying the location of a cooperative aerial vehicle.

FIG. 6 is an image of the user interface of FIG. 4 as it displays the future flight plan of a cooperative aerial vehicle that is not already in flight.

FIG. 7 is an image of the user interface of FIG. 4 as it displays the flight plan and flight data of a cooperative aerial vehicle that is in flight.

FIG. 8 is an image of the user interface of FIG. 4 as it displays both the future flight plan of a cooperative aerial vehicle that is not already in flight and an arrow indicating the position of a communicative aerial vehicle.

FIG. 9 is an image of the user interface of FIG. 4 as it displays the original flight plan and the changed flight plan of a cooperative aerial vehicle that is in flight.

### DETAILED DESCRIPTION

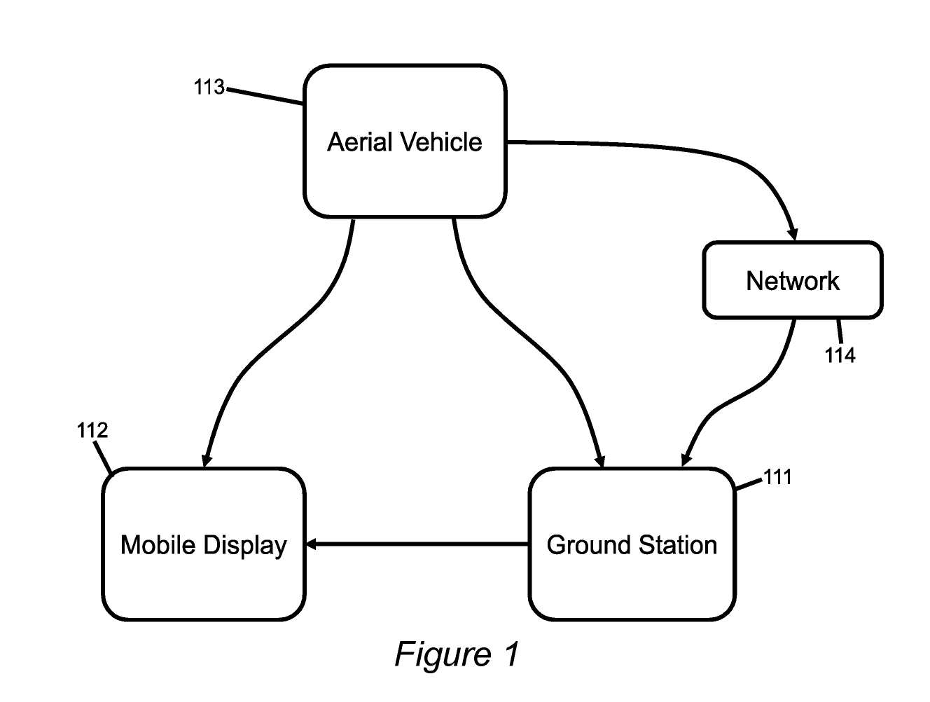

As illustrated in FIG. 1, a system includes a display, a camera, and a computing device. As portrayed in the figure, the mobile display 112 may be, or may include, the display, camera, and the computing device (e.g., tablet, smartphone, mobile computing device, etc.). In some embodiments, the display, camera, and computing device are integrated into a single device, such as a tablet. In other aspects, the camera, display, and computing device are separate components that are communicatively linked. In other aspects, the system may contain a video camera that is attached to a computer that contains both the display and the computing device. Yet, in other aspects, all components are separate and/or distributed.

The system allows for wireless communications and data transmission between the computing device and at least one aerial vehicle. Shown in FIG. 1 is a schematic representation of the wireless data transmission flow from the aerial vehicle 113, which may be a primary aircraft, to a computing device of mobile display 112. The data transmission may include wireless communications directly from the aerial vehicle 113 to the computing device of mobile display 112. In other aspects, the data transmission is directed through a ground station 111 where the ground station is in wireless communication with the computing device of mobile display 112. In both circumstances, the computing device is communicatively coupled with the display and a camera. FIG. 1 also shows flight data transmission from the aerial vehicle 113, which may be a cooperative aerial vehicle, to the computing device of mobile display 112 through a network 114. For example, the network 114 can include any suitable public, private, wired, wireless, and/or other communications links. In this embodiment, the flight data is transmitted through the network 114 to the ground station 111 and the flight data is then transmitted to the computing device, which may be communicatively coupled to a display and a camera, of mobile display 112. Any or all data transmission routes can be used to send flight plan data from the computing device back to the aerial vehicle 113 (e.g., if it is a cooperative aerial vehicle).

In some aspects, the flight data that is received by the system includes the current location and altitude of the aerial vehicle. The flight data can also include the future flight plan of the aerial vehicle. The flight plan includes the planned future position of the aerial vehicle. In some aspects, the flight plan includes the future position of the aerial vehicle throughout the entire flight of the aerial vehicle. In other aspects, the future flight plan includes the planned future position of the aerial vehicle for only a portion of the flight time. In some aspects, the computing device receives updates on the flight data in real time.

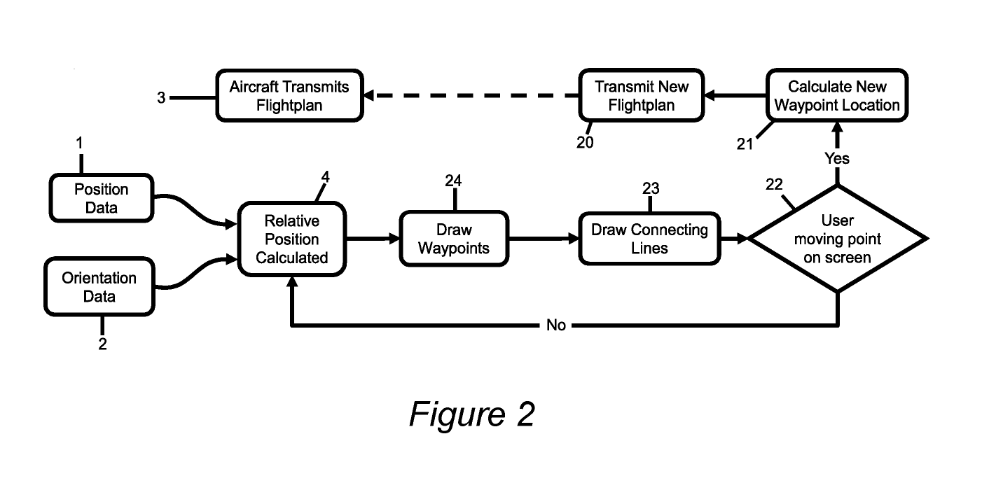

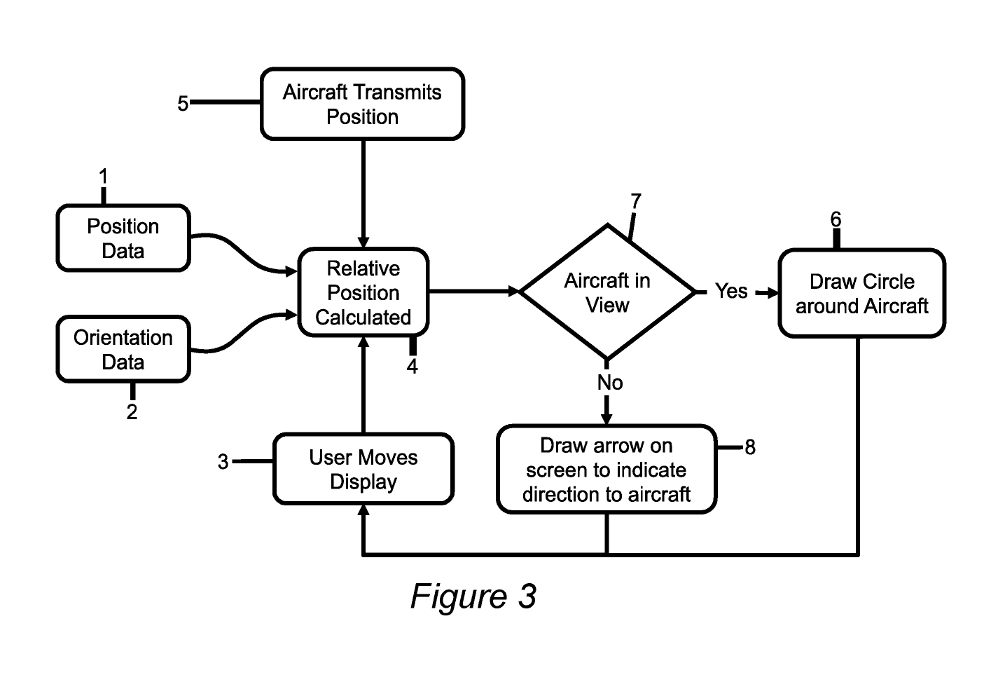

FIGS. 1, 2 and 3 show schematic representations of the method for creating and changing the future flight plan of a cooperative aerial vehicle 113. The position of the aerial vehicle is transmitted to the computing device (Block 5) through the methods described above and the computing device calculates the relative position (Block 4) of the camera to the aerial vehicle. The relative position is calculated (Block 4) by determining the position data (Block 1) and the orientation data (Block 2) of the camera relative to the aerial vehicle position (Block 5) (shown in FIG. 3). Using this information, waypoints (Block 24) can be identified on the user interface that are then connected by drawing connecting lines (Block 23) to create the future flight plan. The user can then look at the flight plan and determine whether the flight plan needs to be changed for any reason, including to avoid obstacles in the way of the flight path. If the flight plan needs to be changed, the user can move the waypoints on the display (Block 21). The new flight plan data is then transmitted (Block 20) to the cooperative aerial vehicle, which may then execute the new flight plan.

FIG. 3 shows a schematic representation of how the system identifies and portrays the position of a cooperative or communicative aerial vehicle. The position of the aerial vehicle (Block 5) is transmitted to the computing device through the methods described above and the computing device determines the relative position (Block 4) of the camera to the aerial vehicle. The relative position (Block 4) is calculated by determining the position data of the camera (Block 1) and the orientation data (Block 2) of the camera relative to the aerial vehicle position (Block 5). Using this information, if the aircraft is in the view of the camera (Block 7), a circle, for example, is drawn around the aircraft (Block 6) on the display. The circle is overlaid on top of the real time video image of the surrounding environment. If the aerial vehicle is not in the current view of the camera (Block 7), an arrow is drawn on the edge of the display that is closest to the position of the aerial vehicle. The arrow may be depicted at other or multiple areas of the display, such as the top, bottom, or middle of the display instead of or in addition to the edge of the display. The arrow points in the direction of the aircraft (Block 8). The user can change the position and orientation of the camera so that an aerial vehicle that is not in the current view of the camera can become in the view of the camera.

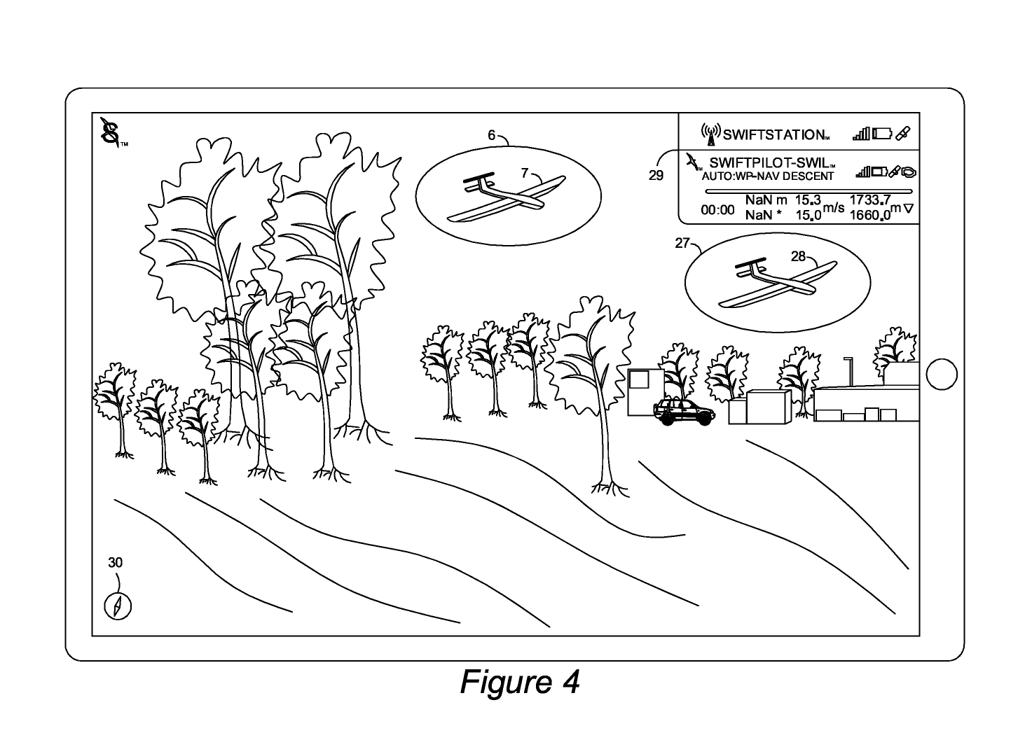

A user interface, shown in FIGS. 4-9, would typically appear on the display that is communicatively coupled to the computing device and the camera. The display and user interface controls can be implemented in any suitable manner. For example, the display can be a touch-screen display, such that a user can interact with the user interface via the touch screen. The user interface can be used to remotely control cooperative aerial vehicle(s) 7. An aerial vehicle is cooperative with the computing device when the state of the aerial vehicle can be modified over the communication channel. For example, the computing device may transmit a new flight plan command from the user interface to the aerial vehicle for the aerial vehicle to execute. The interface may provide for a user to view and control the flight of a cooperative aerial vehicle 7 while also allowing the user to view the location of other communicative aerial vehicle(s) 28. An aerial vehicle is communicative with the system when the aerial vehicle's location data can be transmitted to the system, but the system may or may not have the capability to alter the flight plan or transmit other data back to the aerial vehicle. In this way, the location of multiple aerial vehicles may be monitored, and cooperative aerial vehicle(s) 7 can be controlled through the single user interface.

FIG. 4 illustrates a user interface or display showing the locations of both a cooperative aerial vehicle 7 and a communicative aerial vehicle 28. The location of the aerial vehicles are overlaid on the real time video image and displayed on the display. The user interface or display illustrates the location of the communicative aerial vehicle 28 by drawing a circle 27 around the location of the vehicle relative to the camera's position and orientation. A circle 6 is also drawn around the position of the cooperative aerial vehicle 7 relative to the camera's position and orientation. The position of the aerial vehicles 7 and/or 28 can also be displayed by different markings. It can be appreciated that sometimes the aerial vehicle(s) 7 and/or 28 will be far away from the camera and the user will not be able to view the actual aerial vehicle(s) 7 and/or 28. The circles 6 and 27 that are drawn around the aerial vehicles 7 and 28, respectively, will help the user to be able to know the current location of said aerial vehicles.

In some embodiments, the user interface may include flight information 29 of the aerial vehicle(s) 7 and/or 28. Some aspects of flight information may include data that is received by the system from the aerial vehicle(s) 7 and/or 28, including, without limitation, the current location and/or altitude of the aerial vehicle(s), the speed of the aerial vehicle(s), the remaining battery life of the aerial vehicle(s), temperature and/or wind information, and/or the quality of the communicative link between the aerial vehicle(s) and the system. One having skill in the art would appreciate that many different data may be appropriate to include in flight information 29. In some embodiments, the user may be able to select what data of flight information 29 is shown on the user interface. FIGS. 4-9 depict flight information 29 in one location; however, it should be appreciated that different flight information may be exhibited in different locations on a user interface, and that some data may be exhibited in multiple places on a user interface.

In some embodiments, the user interface may include a compass 30. In some implementations, the compass 30 indicates a real-time direction in which the aerial vehicle is flying. The real-time direction can be displayed in any suitable reference framework, such as in reference to true north, in reference to the direction in which the user is facing, etc.

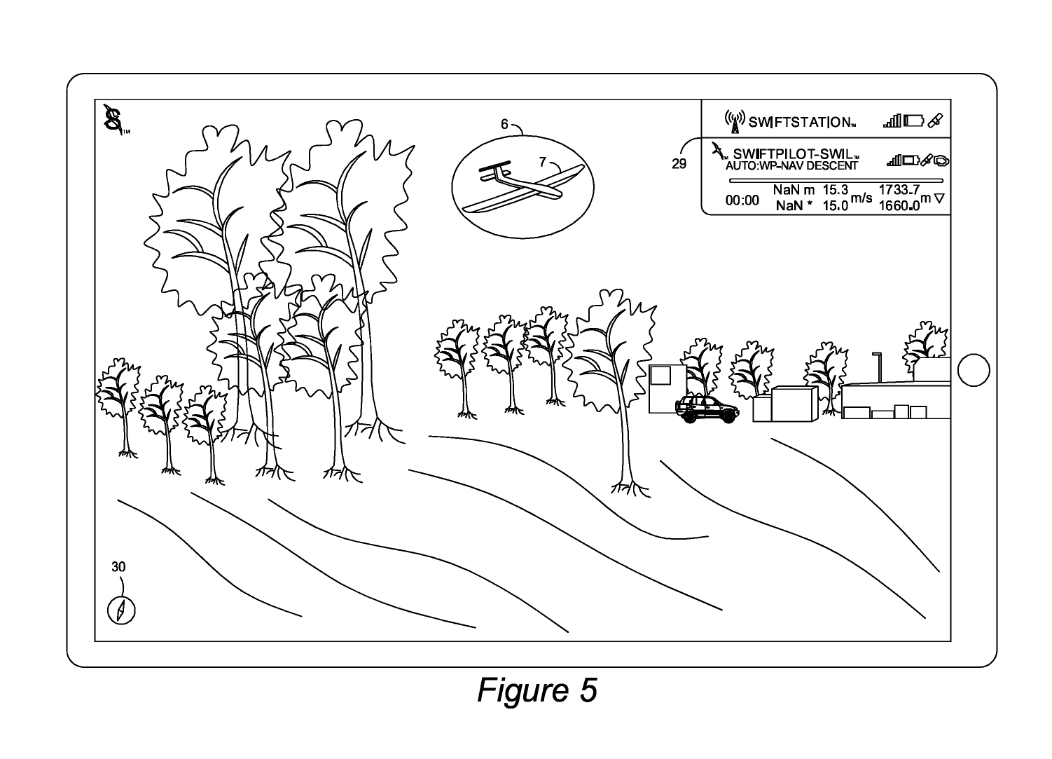

FIG. 5 illustrates that in some circumstances, only a single cooperative aerial vehicle's 7 location will be identified on the user interface. In these instances, a circle 6 drawn around the aerial vehicle identifies the location of the aerial vehicle.

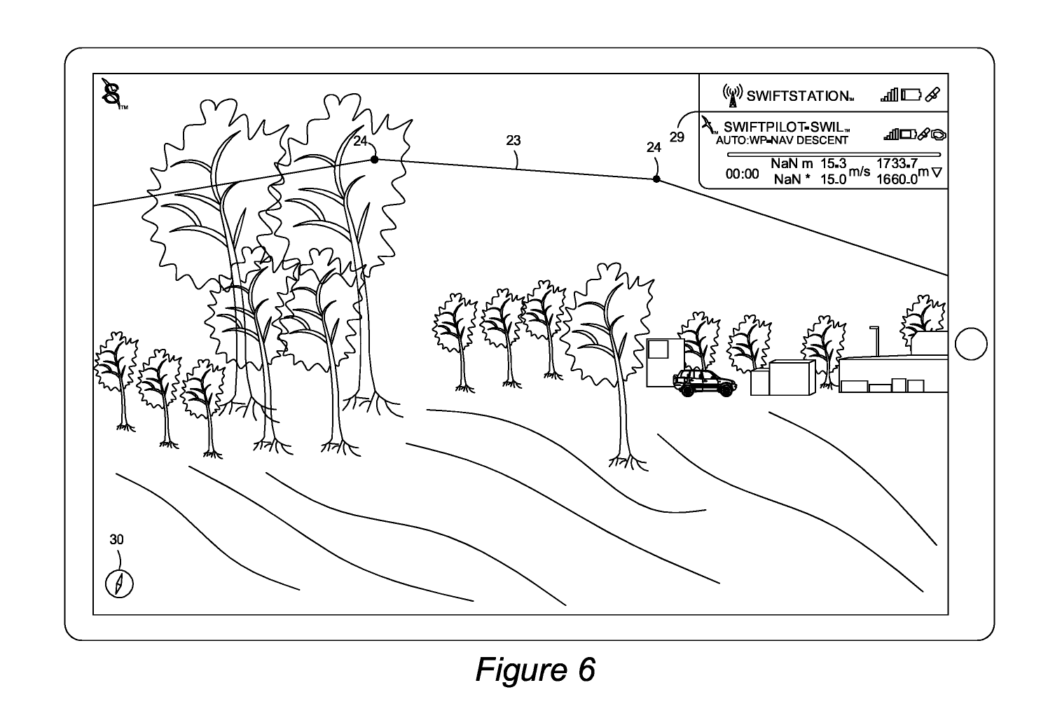

FIG. 6 illustrates a predetermined flight plan that is overlaid on a real time image that has been relayed from the camera as it appears on the user interface on the display. The displayed flight plan is for an aerial vehicle that is not yet in flight. A flight plan may include multiple waypoints 24 that are connected by drawing connecting lines 23 in between the points. Waypoints 24 are user-specified positions that can be represented on the display by a waypoint indication. The indicator for waypoints 24 may be any appropriate marking, such as a dot, X, or circle. The position of the waypoints 24 can be used to direct the aerial vehicle to that certain position, or multiple waypoints 24 can be connected to create a future flight plan for the aerial vehicle.

Depending on the capabilities of the computing device, display, and camera, upon which the user interface is implemented, user input may allow for flight plan creation through finger or stylus taps on a touchscreen, mouse clicks with a pointer, the use of keys on a keypad, and/or some other method, to select the waypoints 24 and draw the connecting lines 23.

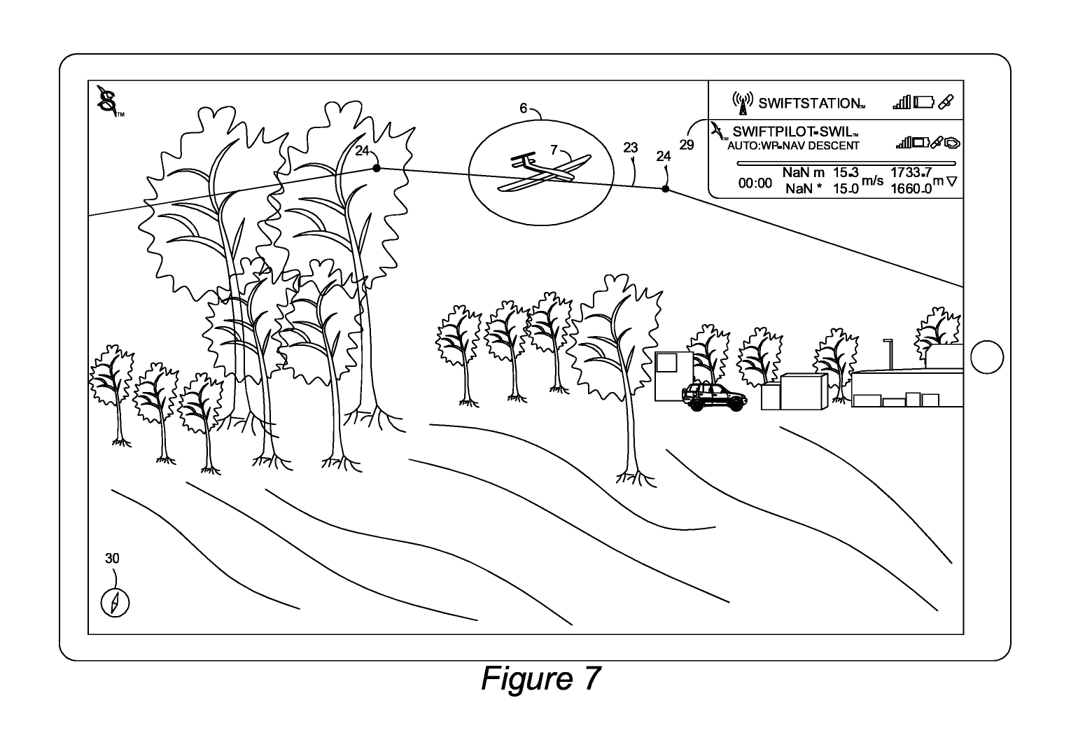

FIG. 7 portrays a predetermined flight plan that is overlaid on a real-time image that has been relayed from the camera as it appears on the user interface on the display. The displayed flight plan is for an aerial vehicle 7 that is already in flight. As illustrated, a circle 6 on the user interface marks the current position of the aerial vehicle. Alternatively, the current position of the aerial vehicle can also be displayed using any other suitable markings.

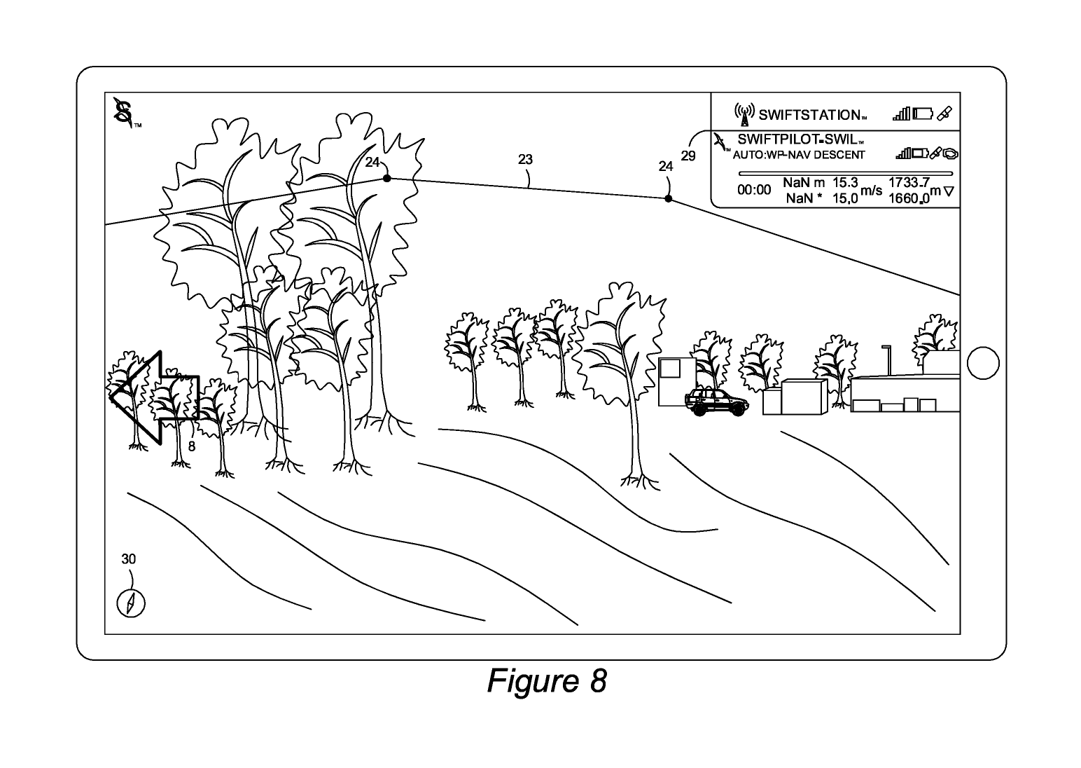

FIG. 8 shows the user interface with both the projected future flight of an aerial vehicle and an arrow 8 representing the position of a cooperative or communicative aerial vehicle that is not in the current view of the camera.

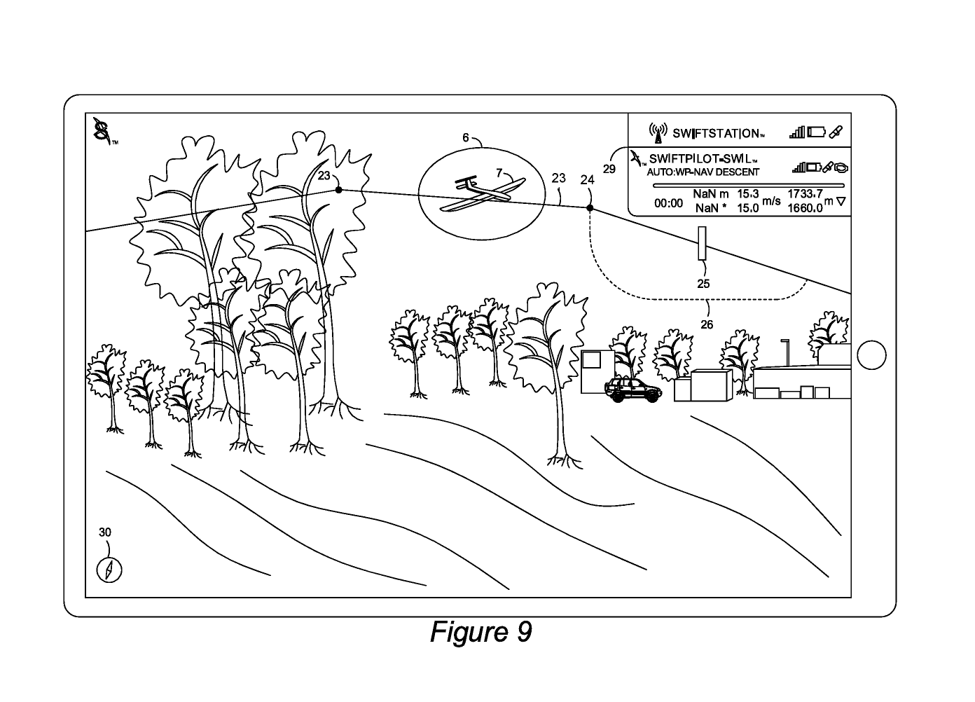

FIG. 9 illustrates the changed future flight plan for a cooperative aerial vehicle 7 that is already in flight. The original flight plan is composed of waypoints 24 and connecting lines 23 drawn to connect the waypoints 24. When an obstacle 25 is within the planned future flight path, the future flight plan can be altered to avoid the obstacle. To change the flight plan, the user chooses different waypoints 24 on the user interface by touching the location of the new waypoint 24 on the display and new connecting lines 26 are drawn so that the aerial vehicle can avoid the obstacle. Furthermore, FIG. 9 shows the original flight plan and the altered flight plan, as they would be viewed on the user interface. The future flight plan or waypoint route is visually integrated with the real-time video input from the camera. Some figures referred to herein include examples of embodiments that contain depictions that may resemble trademarks or trade names. Some names, terms, or logos used herein may be registered or unregistered trademarks or product names of Black Swift Technologies LLC. The use of any such trademarks without the prior consent of the holder is prohibited. Such depictions represent only the idea of such an identifier being used in association with the embodiment and do not in any way limit the scope of the claims to the use of such trademarks or trade names. Unless clearly marked as a trademark, any resemblance of any of the depictions in the figures to any actual trademark or trade name is completely unintentional and merely coincidental.

While a number of aspects and embodiments have been discussed above, persons having ordinary skill in the art will recognize certain modifications, permutations, additions, and equivalents may alternatively be used or introduced. It will therefore be readily be appreciated that many deviations may be made from the specific embodiments disclosed above, and it is intended that the scope of the following claims are interpreted to include all such modifications, permutations, additions, and equivalents. The terms and expressions used herein are for illustration, not limitation, and there is no intention to exclude any equivalents of the aspects shown and described.

What is claimed is:

1. A system for displaying information related to flight of an aerial vehicle comprising:
a display;
a camera that operates to capture real-time video input from a surrounding environment; and
a computing device, communicatively coupled with the display, the camera, and an aerial vehicle, wherein the computing device operates to:
map a present location and an orientation of the camera to a display coordinate system;
map flight data for the aerial vehicle to the display coordinate system; and
display, on the display, a real-time video output comprising a visual integration of the flight data with the real-time video input in the display coordinate system according to a present location and orientation of the camera.

2. The system of claim 1, wherein the flight data for the aerial vehicle comprises a flight plan that indicates a planned future position of the aerial vehicle.

3. The system of claim 1, wherein the camera communicates the present location and orientation to the computing device.

4. The system of claim 1, wherein the flight data indicates a current position of the aerial vehicle.

5. The system of claim 1, wherein the flight data indicates an estimated future position of the aerial vehicle.

6. The system of claim 1, wherein the computing device is cooperative with the aerial vehicle.

7. The system of claim 1, wherein the computing device further operates to:
receive a real-time updates of the flight data; and
update, in real-time on the display, the real-time video output in accordance with the real-time updates.

8. The system of claim 1, wherein the computing device further operates to:
receive a flight path command via a user interface; and
alter the flight plan in real time in response to the flight path command.

9. The system of claim 1, wherein:
the aerial vehicle is one of a plurality of aerial vehicles;
the computing device is communicatively coupled with the plurality of aerial vehicles; and
the visual integration further comprises visual integration of flight data for the plurality of aerial vehicles with the real-time video input in the display coordinate system image according to the present location and orientation of the camera.

10. The system of claim 1, wherein the computing device further operates to display the real-time video output by displaying an arrow indicating a direction of a present location of the aerial vehicle with respect to the real-time video input when the aerial vehicle is not visible within the real-time video input.

11. The system of claim 1, wherein the aerial vehicle is in wireless communication with a ground station and the ground station is in wireless communication with the computing device.

12. The system of claim 1, wherein the aerial vehicle is in communication directly with the computing device.

13. The system of claim 1, wherein the aerial vehicle is in communication with the computing device via a network.

14. The system of claim 1, wherein the computing device, the display, and the camera are integrated into a single device.

15. A process for displaying flight data of at least one aerial vehicle from the ground, the process comprising:
receiving with a computing device signals relayed from a location device, the location device coupled with a camera, the signals specifying a spatial orientation of the camera;
receiving with the computing device signals relayed from at least one aerial vehicle, the signals indicating a location of the at least one aerial vehicle;
computing the spatial orientation of the camera in relation to the location of the at least one aerial vehicle;
transmitting to a display the spatial orientation of the camera in relation to the location of the at least one aerial vehicle;
rendering, on the display, a real time image relayed from the camera visually integrated with a visual indication of the spatial orientation of the camera in relation to the location of the at least one aerial vehicle;
receiving with the computing device updated signals from the location device and the at least one aerial vehicle, the updated signals specifying an updated orientation of the camera in relation to the at least one aerial vehicle; and
rendering, on the display, a real time image relayed from the camera visually integrated with a visual indication of the updated orientation of the camera in relation to the location of the at least one aerial vehicle.

16. The process of claim 15 further comprising:
displaying a predetermined flight plan representing a future position of the at least one aerial vehicle.

17. The process of claim 15 further comprising:
displaying, on the display, one or more obstacles that intersect a future flight path of the at least one aerial vehicle.

18. The process of claim 15 further comprising:
adjusting a future flight path of a cooperative aerial vehicle in real-time to avoid any obstacles displayed on the display.

19. A system for facilitating avoidance of obstacles by a cooperative aerial vehicle comprising:
a display;
a camera that operates to capture a real-time video input from a surrounding environment, the camera coupled to an inertial measurement unit (IMU); and
a computing device communicatively coupled with the display, the camera, and a cooperative aerial vehicle, wherein the computing device operates to:
map a present location and orientation of the camera, the present location and orientation relayed to the computing device;
map flight data for the cooperative aerial vehicle to a display coordinate system;
display, on the display, real-time video output comprising visual integration of the flight data with the real-time video input in the display coordinate system according to the present location and orientation of the camera; and
revise on the real-time video output, in real time, a position of a visual indication of a future location of the aerial vehicle.

20. The system of claim 19, wherein the computing device further operates to detect a user interaction that changes the position of the visual indication and in response to the detecting, updates a flight plan in the flight data for the cooperative aerial vehicle.
